(19) United States
(12) Patent Application Publication
(10) Pub. No.: US 2019/0300396 A1
(43) Pub. Date: Oct. 3, 2019

(54) METHOD AND APPARATUS FOR IMPROVED FILTRATION BY A CERAMIC MEMBRANE

(71) Applicant: Wilsa Holdings, LLC, Houston, TX (US)

(72) Inventor: Herbert William Holland, Houston, TX (US)

(21) Appl. No.: 16/368,198

(22) Filed: Mar. 28, 2019

Related U.S. Application Data
(60) Provisional application No. 62/649,189, filed on Mar. 28, 2018.

(51) Int. Cl. C02F 1/48; C02F 1/44; B01D 71/02; B01D 61/14; B01D 61/16

(52) U.S. Cl. CPC C02F 1/484; C02F 1/444; C02F 2101/32; B01D 61/145; B01D 61/16; B01D 71/02

(57) ABSTRACT

A method of increasing the rate by which a dissimilar material separates from an aqueous-based fluid mixture is disclosed. The method includes the step of passing an aqueous-based fluid through a magnetically conductive conduit having magnetic energy directed along the longitudinal axis of the magnetically conductive conduit and extending through at least a portion of the aqueous-based fluid mixture thereby providing a conditioned fluid medium. The conditioned fluid medium is separated into at least two distinct phases in a ceramic membrane filtration apparatus downstream of the magnetically conductive conduit, wherein at least one dissimilar material separates from the conditioned fluid medium at an increased rate as compared to a rate of separation of at least one dissimilar material from an aqueous-based fluid mixture prior to passing through the magnetically conductive conduit.

### INCORPORATION BY REFERENCE

The present patent application claims priority to the provisional patent application identified by U.S. Ser. No. 62/649,189 filed on Mar. 28, 2018, the entire contents of which are hereby incorporated by reference.

### BACKGROUND

Water is one of the most important, yet least understood, substances known to man. From its irregular molecular structure, unusual intermolecular interactions, and uniquely high surface tension; water is the liquid that both man and nature have always focused on tricking into wetting things more completely, and/or emulsifying more normally hydrophobic materials.

Large amounts of water are utilized in exploration and production, power generation, refining, mining, ethanol production, food and beverage processing, paper, chemical and pharmaceutical manufacturing, and other municipal and industrial activities to produce commodities.

Municipal, industrial and manufacturing facilities utilize filtration methods to remove contaminants from raw water sources and generate water for steam generation, cooling, fabricating, processing, washing, diluting, thermal exchange, transporting products and/or sanitation needs. Filtration is also utilized in recycling water for addition use, adding value to products or treating contaminated water and wastewater for discharge into the environment. Water purification and desalination are also used to produce drinking water pure enough for human consumption.

Filtration is utilized to improve the appearance, smell and taste of water and remove contaminants, including parasites, such as Cryptosporidium or Giardia, bacteria, algae, viruses, fungi, minerals, toxic metals such as lead and copper, and man-made chemical pollutants.

In some instances, membrane filtration may be used in place of an existing secondary filtration system (coagulation, flocculation, sedimentation) and tertiary filtration system (sand filters) as a stand alone system to remove particulates and macromolecules from raw water to produce potable water. Membrane filtration can also be utilized as a pretreatment stage for desalination systems, such as distillation systems, or to protect reverse osmosis membranes.

Membrane filtration relies on size exclusion and/or particle capture to remove contaminants from water by utilizing forces such as pressure or concentration gradients to propel water through a separation apparatus. Suspended solids, solutes having a high molecular weight and some water typically retained in the retentate, which does not pass through the filtration media, while water and low molecular weight solutes pass through the filtration media in the permeate (filtrate).

Many environmental and cost considerations affect the design and operation of water filtration systems. Membrane filtration is typically preferred over many other water treatment methods because of its capacity to achieve and exceed regulatory standards for water quality via consistent extraction of 90%-100% of water-borne pathogens, consistently high quality of the permeate (regardless of raw water feedstock quality), provide water in the <1.0 nephelometric turbidity units (NTU) range of drinking water, relatively small equipment size and low chemical consumption.

### SUMMARY

While the relatively high cost incurred due to membrane fouling and replacement of membranes has previously been a limiting factor in the acceptance of membrane filtration, the limitations of high costs for operating and maintaining membrane filtration systems has been significantly reduced by recent discoveries.

As disclosed herein, a system and method has been developed whereby a fluid containing at least one polar substance can have one or more of its cohesion energy, viscosity, and/or contact angle against a dissimilar material altered by subjecting the fluid to a magnetic field having a sufficient amount of force to alter at least one physical property of the fluid. A magnetically conditioned aqueous-based fluid may have improved efficiencies in membrane filtration, and more specifically, ceramic membrane filtration, wherein contaminants are separated from water at a reduced pumping pressure, as well as an increased flux rate by which water can be propelled through a ceramic membrane.

As used herein, the term “fluid containing at least one polar substance” may encompass water, aqueous-based solutions, aqueous-based mixtures, aqueous solutions, and/or combinations thereof as well as any other fluids containing at least one polar substance as would be known to those of ordinary skill in the art.

Also, as described herein, a fluid containing at least one polar substance may also be present in a mixture comprising the fluid containing at least one polar substance and at least one dissimilar material, wherein the “at least one dissimilar material” is defined herein to encompass hydrocarbon compounds, autotrophic organisms, biological contaminants, chemical compounds, solids, fats and/or combinations thereof. A mixture of a fluid containing at least one polar substance and at least one dissimilar material is also referred to herein simply as an “aqueous-based fluid mixture”.

Additionally, as used herein, a “conditioned fluid medium” is a fluid containing at least one polar substance and/or an aqueous-based fluid mixture that has been magnetically conditioned using the apparatus and method(s) described herein.

As also used herein, the term “aqueous-based fluid mixture(s)” is used to refer to water-based streams that may include raw water sources, such as oceans, lakes, rivers, streams, swamps, marshes or aquifers, wastewater, water discharged from fabrication and manufacturing processes, water utilized in thermal exchange systems, water generated in oil and gas production, marine bilge and/or ballast water, and/or combinations and equivalents thereof which comprise water (i.e., “a fluid containing at least one polar substance”) as well as at least one dissimilar material (as defined above).

As also used herein, the term “flux rate” is used to refer to the flow rate of a filtrate (water) passing through a membrane per unit area of the membrane. The flux rate in a cross flow membrane system may be calculated using the following equation: J=ΔP/(Rₘ+R_{c})μ, wherein J is the liquid flux rate, ΔP is the transmembrane pressure (TMP), Rₘ is the resistance of the membrane (related to overall porosity), R_{c} is the resistance of the cake (variable; and related to fouling of the membrane by contaminant accumulating on the surface of the membrane) and μ is the viscosity of the liquid. Because Rₘ and R_{c} include the inverse of the membrane surface area in their derivation; thus, flux rate increases with increasing the area of a membrane.

Another equation for flux rate is J=Qₚ/Aₘ, wherein J is the flux rate, expressed in liters per hour per square meters of surface area (L/hr/m²) or gallons per day per square feet of surface area (gal/d/ft²); Q is the flow rate of a filtrate through membrane, (L/hr or gal/d) and Aₘ is the surface area of membrane, (m² or ft²). The flux rate L/hr/m² may typically be abbreviated as Lmh and the flux rate gal/d/ft² (gallons per day through a square foot of surface area) may typically be abbreviated as gfd. As an example of calculating flux rate, if 200,000 gal/d were flowing through a membrane having an area of 4,000 ft², the flux rate would be (200,000 gal/d)/(4,000 ft²)=50 gfd (85 Lmh).

Changing the physical properties of fluids containing at least one polar substance, including the above-defined “aqueous-based fluid mixtures”, can be useful in the separation of solids and other materials from water. Additionally, the ability to alter the physical properties of an aqueous-based fluid mixture to provide a conditioned fluid medium after magnetic conditioning, whereby the cohesion energy of the conditioned fluid medium is less than the cohesion energy of the aqueous-based fluid mixture prior to being subjected to the magnetic field, the viscosity of the conditioned fluid medium is less than the viscosity of the aqueous-based fluid mixture prior to being subjected to the magnetic field, and the contact angle of the conditioned fluid medium against a dissimilar material is greater than the contact angle of the aqueous-based fluid mixture against a dissimilar material prior to being subjected to the magnetic field, to increase the flux rate of the fluid propelled at a constant pressure or reduce the pressure required to maintain a constant flux rate of the fluid may have impacts in a variety of industries by increasing productivity and/or reducing costs.

In light of the above, there is a need for both an apparatus and method capable of altering one or more physical properties of a fluid containing at least one polar substance and/or an aqueous-based fluid mixture by subjecting the fluid to a magnetic field having a sufficient amount of force to alter at least one of the cohesion energy, viscosity and/or contact angle against a dissimilar material of the fluid, whereby, depending on the conditions of the method and apparatus, the fluid may have improved separation properties and/or enhanced pumping and/or flow characteristics.

The presently claimed and/or disclosed inventive concept(s) for conditioning fluids includes the step of directing an aqueous-based fluid mixture through a magnetically energized conduit in order to provide a conditioned fluid medium (also referred to herein as simply a “conditioned fluid”) and then directing the conditioned fluid medium to pass through a ceramic membrane. Such conditioned fluid mediums are found to have improved efficiency of oil/water separation, water/solids separation, and oil/water/solids separation as well as provide for lower transmembrane pressures at constant flux rate, increased flux rate at constant pressure and increased rates by which contaminants separate from a fluid containing at least one polar substance, depending on the conditions of the apparatus and methods used to magnetically condition the fluid.

As disclosed in U.S. patent application Ser. No. 15/797,829, the entire content of which is hereby incorporated herein by reference, the magnetically conductive conduit may establish at least one gradient of one or more magnetic fields established in substantial orthogonal alignment to the flow path extending through the conduit. Therefore, it can be appreciated that magnetic energy is concentrated in a plurality of distinct areas along the longitudinal axis of a magnetically energized conduit.

### BRIEF DESCRIPTION OF THE DRAWINGS

FIG. 1 is a schematic diagram of a magnetically conductive conduit and a ceramic membrane filtration apparatus.

FIG. 1A is a schematic diagram of a magnetically conductive conduit, a first membrane filtration apparatus, and a second membrane filtration apparatus.

### DETAILED DESCRIPTION

The basic operating principle of membrane filtration is the separation of contaminants from an aqueous-based fluid mixture forced to pass through a semi permeable membrane under pressure. The relationship between the applied pressure on the aqueous-based fluid mixture to be filtered and the flux rate through the membrane is most commonly described by the Darcy equation: J=TMPμRt, wherein J is the flux rate, TMP is the transmembrane pressure (pressure difference between feed and permeate stream), μ is the viscosity of the water and Rt is the total resistance (the sum of the membrane resistance and any fouling resistance).

During the filtration process, the concentration of rejected material at the surface of the membrane increase and become saturated. As a concentrated layer of contaminants accumulates on the wall of a membrane, fouling of the membrane may occur and the flux rate of the permeate through the membrane is reduced due to increased resistance provided by the constantly increasing layer of contaminants on the membrane wall, effectively reducing the driving force of the aqueous-based fluid mixture through the membrane.

At periodic intervals during the filtration process, cleaning of the membrane is conducted to remove the concentrated layers of contaminants that accumulate on the wall of a membrane. Regular backwashing is often conducted every 10-15 minutes for some processes to remove cake layers formed on the membrane surface. Membrane filtration utilizes a system of valves that automatically “open” or “close” during normal filtration and backwashing cycles to direct water through a membrane. During the normal filtration of an aqueous-based fluid mixture, one or more “filtration valves” of a system are switched to an “open” state to allow an aqueous-based fluid mixture to flow through a first inlet port and flow in a first direction through the membrane(s) to provide for the accumulation of contaminants on the surface(s) of the membrane(s) and allow water and low molecular weight solutes to pass through the membrane, while one or more “backwash valves” of the system are switched to a “closed” state.

As the accumulation of solids on the surface(s) of the membrane(s) within the system cause the transmembrane pressure of the system to reach a set point, the one or more “filtration valves” of the system will switch to a “closed” state and the one or more “backwash valves” of the system will switch to an “open” state. The system may include a differential pressure gauge having a first inlet port located on upstream side of the membrane, and a second inlet port on a downstream side of the membrane, and a control system. The control system receives signals from the differential pressure gauge and monitors the signals relative to a backwash set point. When the backwash set point is reached, the control system sends signals to the filtration valve(s) and the backwash valve(s) to initiate a backwashing cycle. The set point can be predetermined or dynamic. During a backwashing cycle, a portion of the permeate stream is pressurized and forced to flow through a second inlet port of the system and through the membrane(s) in a second direction to dislodge accumulated particles and other contaminants from the surface(s) of the membrane(s) to improve the flux rate of the system. The flow of a portion of the permeate in a second direction provides for the accumulation of suspended solids and solutes having a high molecular weight dislodged from the surface(s) of the membrane(s) to form the retentate that flows through a second outlet port of the system.

Once a backwashing cycle has been completed, the system will return to the normal filtration of an aqueous-based fluid mixture, and the one or more “filtration valves” of a system will be switched to an “open” state to allow an aqueous-based fluid mixture to resume its flow through the system in a first direction while the one or more “backwash valves” of the system will be switched to a “closed” state.

The process characteristics of a membrane filtration system are dependent on the type of membrane used and its application. Depending on the shape and material of the membrane, different modules can be used for membrane filtration process. Membrane filtration systems vary according to hydrodynamic and economic requirements, as well as mechanical stability under a range of operating pressures.

The tubular module design uses either polymeric membranes cast on the inside of plastic or porous paper components, or ceramic membranes, with diameters typically ranging from 5-25 mm with lengths from 0.6-6.4 m. Multiple tubes are housed in a PVC or steel shell. The feed of the module is passed through the tubes, accommodating radial transfer of permeate to the shell side.

Hollow fiber membranes are polymeric and similar to the tubular module design having a shell and tube arrangement. A single module can consist of 50 to thousands of hollow fibers that are self-supporting, unlike the tubular design. The diameter of each fiber may range from 0.2-3 mm, with the feed flowing in the tube and the permeate collected radially on the outside. The advantage of self-supporting membranes is their ease of cleaning due to their ability to be backwashed.

Spiral-wound modules are formed with a combination of flat membrane sheets separated by a thin meshed spacer material that serves as a porous plastic screen support. The sheets are rolled around a central perforated tube and fitted into a tubular steel pressure vessel casing. As a pressurized aqueous-based fluid mixture passes over the membrane surface, the permeate spirals into the central collection tube. Spiral-wound modules are a compact and relatively inexpensive membrane filtration design providing high volumetric throughput and simple cleaning.

Plate and frame membrane systems utilize a membrane placed on a flat plate separated by a mesh like material. An aqueous-based fluid mixture directed to pass through the system allows the permeate separated from the mixture to be collected from the edge of the plate. Channel length can range from 10-60 cm and channel heights from 0.5-1 mm. Plate and frame membranes provide low volume restriction, relatively easy replacement of the membrane and the ability to filter viscous fluids because of the low channel height unique to this particular design.

An aqueous-based fluid mixture may typically be treated prior to membrane filtration to prevent damage to the membrane and minimize the effects of fouling, which greatly reduces the efficiency of separation. Pre-treatment are often dependent on the type and/or quality of an aqueous-based fluid mixture. Other types of pre-treatment common for many membrane filtration processes include pH balancing and coagulation. Water with high levels of suspended solids typically requires pretreatment with a primary screening, flotation and/or coarse filtration stage and some type of secondary treatment stage (typically low dosages of coagulants and/or flocculants) upstream of a filtration system. For example, in wastewater treatment, household waste and other particulates are screened. Appropriate sequencing of each pre-treatment phase is crucial in preventing damage to subsequent stages.

Most membranes are made with either polymeric materials, such as polysulfone, polyethersulfone, polyvinylidene fluoride, polypropylene, cellulose acetate, polylactic acid and other materials, or ceramic materials, such as alumina, titania, zirconia oxides, silicon carbide, and other inorganic materials.

The permeability of the membrane material typically has a pore size one-tenth the size of the particle to be removed from the water. This typically limits the number of smaller particles that can enter the pores of the membrane and be adsorbed on to its surface. Membranes utilized in pressure-driven separation processes are typically classified according to the pore diameter of the membrane material. Reverse osmosis membranes typically have a pore size of <1 nm, membranes typically have a pore size of <1 nm, dialysis membranes typically have a pore size of 2-5 nm, ultrafiltration membranes typically have a pore size of 2-100 nm and microfiltration membranes typically have a pore size of 100 nm-2 μm.

Modifying surface properties to reduce fouling tendencies, including altering membrane surfaces to reduce protein binding, has enhanced the properties of membrane. Improved designs also allow for more membrane surface area without increasing the risk of fouling.

Membrane filtration systems may operate with either cross-flow or dead-end flow. In dead-end filtration, the flow of the feed aqueous-based fluid mixture is perpendicular to the membrane surface. In cross flow systems, the flow of the feed aqueous-based fluid mixture passes parallel to the membrane surface. Dead-end configurations are more suited to batch processes with low suspended solids since solids accumulate at the membrane surface require frequent backwashing and cleaning to maintain high flux rates. Cross-flow configurations are preferred in continuous operations as solids are continuously flushed from the membrane surface, resulting in a thinner cake layer and lower resistance to permeation.

Flow velocity is especially critical in preventing excessive fouling when filtering water containing high levels of suspended solids. Higher cross-flow velocities can typically be utilized to enhance the sweeping effect across the membrane surface to prevent deposition of contaminants and colloidal material. In some instances, the temperature of the aqueous-based fluid mixture may effect fouling.

Improved efficiencies in membrane filtration provided by the presently claimed and/or disclosed inventive concept(s) wherein contaminants are separated from a fluid containing at least one polar substance, as well as increasing the flux rate by which an aqueous-based fluid mixture may be propelled through a ceramic membrane at a constant pressure and/or reducing the pressure required to propel an aqueous-based fluid mixture through a ceramic membrane at a constant flux rate, increase the economic and operating benefits provided by such systems.

Fouling of a membrane occurs as contaminants are removed from an aqueous-based fluid mixture and accumulate on the wall of a membrane. Contaminants may be uniformly deposited on pore walls, or a membrane pore may be completely sealed by a contaminant. The accumulation of solids particles and other contaminants forming a fouling layer on the membrane surface is known as cake formation.

Increased ion concentrations may exceed solubility thresholds and precipitate on a membrane surface, forming scale. Inorganic salt deposits can block pores and result in flux rate decline, membrane degradation and/or loss of production. The formation of scale is highly dependent on factors affecting solubility, including pH, temperature, flow velocity and permeation rate.

Microorganisms adhering to a membrane surface may form a gel-like layer known as biofilm. This film increases resistance to flow and acts as an additional barrier to permeation. Blockages formed by biofilm can lead to uneven flow distribution and increase transmembrane pressure.

Cleaning is done regularly to prevent the accumulation of contaminants and reverse the degrading effects of fouling on permeability and selectivity of a membrane. Regular backwashing is often conducted every 10-15 minutes for some processes to remove cake layers formed on the membrane surface. By pressurizing the permeate stream and forcing it back through the membrane, accumulated particles may be dislodged from the membrane and improve the flux rate of the system.

The backwashing process has a limited capacity to remove more complex forms of fouling, such as biofouling, scaling or adsorption to pore walls. High levels of fouling may require the use of aggressive cleaning solutions and the periodic cleaning operations to remove fouling contaminants from a ceramic membrane. Common types of chemicals used for cleaning are acidic aqueous-based mixtures for the control of inorganic scale deposits, alkali aqueous-based mixtures for removal of organic compounds and/or biocides or disinfection such as chlorine or peroxide when biofouling is evident. Adequate time must be allowed for chemicals to interact with contaminants and flow through the pores of a ceramic membrane. Complete cleaning cycle, including rinses between stages, may require several hours.

The utilization of magnetic conditioning according to the presently claimed and/or disclosed inventive concepts to alter the cohesion energy, viscosity, and/or contact angle against a dissimilar material of a fluid containing at least one polar substance (e.g., water) has been discovered to accelerate the rate by which solids and other contaminants separate from water directed to pass through ceramic membrane filtration apparatus.

Ceramic membranes utilize a porous inorganic membrane layer of silicon carbide, aluminum oxide, titanium oxide or zirconium oxide over a porous support, such as alpha alumina. The monolithic, tubular or flat sheet support is made by extrusion, and membrane porosity is formed through proprietary manufacturing and curing processes. Nitrides and carbides of similar metals may also be used as the barrier layer. The porous layer will have distinct pores ranging from 0.5-0.02 microns, with the typical pore sizes being a nominal 0.1 micron.

Elements come in different lengths and diameters depending on the application and vendor specifications. Some may be as long as 1500 mm (5 feet) long. Widths may also vary. Filter channels may range from one very wide channel in a membrane to as many as 85 very narrow passageways with inside diameters of 1.0-25 mm (0.6-1.0 inches), with the diameter of the feed channels impacting the overall membrane surface area.

A ceramic membrane will have multiple passageways or channels for the feed to flow. The filtrate is collected as it exits the exterior surface of the porous material. There are some models of ceramic membranes with slots built into the monolith that collect filtrate and direct it to the outside of the module. The feed channel diameter may be adapted to the viscosity of the liquid to be treated. A pressurized feed stream can run from the inlet end to an outlet face in a cross-flow arrangement.

Ceramic membranes offer reliable operation with a positive barrier against upsets. They are mechanically strong and can be used in applications with oil and suspended solids in the feedstock. They are also abrasion resistant and durable, with a resistance to degradation by a wide range of chemicals and chemical concentrations. This allows more aggressive chemical cleaning procedures to be used. Ceramic membranes also have a high resistance to ozone, which allows for its use as a disinfectant in raw water. They may operate in a pH range of 1-14, are thermally stable and can withstand temperatures up to several hundred degrees F. The limitations for ceramic membranes typically apply only to potting material, gaskets and fittings, and do not apply to the ceramics themselves. High flux rates can be achieved with ceramic membranes since they can tolerate higher operating pressures, allowing for extended process runs. Ceramic membranes typically possess very high thermal stability and high pressure tolerance, with working conditions primarily limited by the sealing materials and vessel structures. Ceramic membranes have a higher permeability than polymeric membranes and can be cleaned to better restore permeability after fouling. Ceramic membranes are hydrophilic while polymeric membranes are hydrophobic providing ceramic some advantage as a filtration material.

Ceramic membranes can have a high packing density like a hollow fiber module. Because there are no fibers, and the ceramic is a durable membrane material, there is no fiber breakage and consequent pinning to perform for integrity control.

As with microfiltration and ultrafiltration operations, ceramic membranes will remove disinfection by-product (DBP) precursors from surface water supply sources via coagulation, and flocculation. They can also remove suspended solids at a >98% water recovery rate due to dead end filtration and high backwash efficiency. Ceramic membranes provide an absolute barrier against upsets or surges in fluctuating raw water quality, which may be characterized by a rapid increase of suspended solids and oils. Reduced losses of the filtrate may be made possible by minimizing some of the separation steps needed in an entire filtration process.

One benefit of lowering the viscosity of an aqueous-based fluid mixture is the reduction in the amount of energy required to move a fluid through a particular filter medium. Changes in contact angle can also be significant with regard to the manner in which water wets a solid. If changes in contact angle significantly enhance wetting, thereby easing the suspension of a dispersed solid, then such changes can be useful. If changes in contact angle significantly diminish wetting, thereby causing the solid to precipitate from a suspension with greater ease, then these types of changes can also be useful. Similarly, increasing the contact angle of water against the surface(s) of solids and/or other contaminants will enhance separation.

In one aspect, the presently claimed and/or disclosed inventive concept(s) is directed to an apparatus for separating at least one dissimilar material from a fluid containing at least one polar substance, wherein the apparatus comprises: (a) a magnetically conductive conduit having magnetic energy directed along the longitudinal axis of the magnetically energized conduit and extending through at least a portion of the magnetically conductive conduit; and, optionally, (b) at least one ceramic membrane filtration apparatus downstream of the magnetically conductive conduit, wherein the at least one dissimilar material and the fluid containing at least one polar substance are capable of flowing through the magnetically conductive conduit and into the ceramic membrane filtration device.

The presently claimed and/or disclosed inventive concepts includes an apparatus for altering the cohesion energy, viscosity, and/or contact angle against a dissimilar material of a fluid containing at least one polar substance and/or an aqueous-based fluid mixture at ambient temperature, including a magnetically conductive conduit having magnetic energy directed along the longitudinal axis of a magnetically energized conduit and extending through at least a portion of the magnetically conductive conduit. The magnetically conductive conduit may have a fluid entry port at the proximal end of the magnetically conductive conduit, a fluid discharge port at the distal end of the magnetically conductive conduit and a fluid impervious boundary wall having an inner surface and an outer surface extending between the fluid entry port and the fluid discharge port, the inner surface of the boundary wall establishing a fluid flow path extending along the longitudinal axis of the conduit. The magnetically conductive conduit may further have at least one electrical conductor having a first conductor lead and a second conductor lead, the electrical conductor coiled with at least one turn to form at least one uninterrupted coil of electrical conductor, each coil forming at least one layer of coiled electrical conductor. The magnetically conductive conduit may further include at least one coiled electrical conductor encircling the magnetically conductive conduit within the coiled electrical conductor, wherein the at least one coiled electrical conductor sleeves at least a section of an outer surface of the boundary wall of the magnetically conductive conduit with at least one turn of the electrical conductor oriented substantially orthogonal to the fluid flow path extending through the conduit. The magnetically conductive conduit may further have at least one electrical power supply operably connected to at least one of the first and second conductor leads, wherein the at least one coiled electrical conductor is thereby energized to provide a magnetic field having lines of flux directed along a longitudinal axis of the magnetically energized conduit. As used herein, the term “magnetically energized conduit” refers to the “magnetically conductive conduit” in an energized state. In each embodiment of the presently claimed and/or disclosed inventive concepts for altering the physical properties of an aqueous-based fluid, it can be appreciated that magnetic energy may be concentrated in a plurality of distinct areas along the longitudinal axis of the magnetically energized conduit.

The at least one ceramic membrane filtration apparatus, as generally described above, may have at least one inlet port, at least one outlet port and a fluid impervious boundary wall extending between the at least one inlet port and the at least one outlet port. In one embodiment, the at least one filtration apparatus may have a fluid impervious boundary wall having an inner surface defining a separation cavity, an inlet port for receiving a fluid containing at least one polar substance and at least one dissimilar material that has been magnetically conditioned by the apparatus described herein into the separation cavity (i.e., “a magnetically conditioned fluid medium”), a first outlet port for discharging a first amount of the (a) fluid containing at least one polar substance and/or (b) the magnetically conditioned fluid medium, each having a reduced volume of the at least one dissimilar material from the separation cavity, and a second outlet port for discharging the at least one dissimilar material separated from the fluid containing at least one polar substance or the conditioned fluid medium discharged in the first outlet port during the backwashing cycle.

As used herein, the filtration apparatus includes a ceramic membrane positioned within a cavity defined by the inner surface of the fluid impervious boundary wall between the inlet port and the first outlet port of a ceramic membrane filtration housing such that the fluid passes through the ceramic membrane having a capacity to separate at least one dissimilar material from an aqueous-based fluid mixture or a conditioned fluid medium by mechanical screening, and/or physical separation may be selected from a group consisting of, but not limited to, separation apparatus utilizing alumina, titania, zirconia oxides, silicon carbide, and other inorganic semipermeable membrane materials, nanoscopic scale materials and other ceramic membrane materials, ultrafiltration apparatus, and combinations thereof or equivalent types of separation apparatus known to those of ordinary skill in the art.

In many instances, directing an aqueous-based fluid mixture to pass through magnetic energy may neutralize the electrical charges of at least one dissimilar material in a fluid, rendering the dissimilar material less adhesive and enhancing the clarification of a fluid containing at least on polar substance. Water utilized as a heat transfer medium in thermal exchange equipment, such as boilers, steam generators, evaporators, condensers, cooling towers, heat exchangers and/or equivalent apparatus known to those of ordinary skill in the art, to transfer heat between one or more fluids, may be directed through concentrated magnetic energy to retard the formation of scale and other heat insulating deposits in such thermal exchange systems. Neutralizing the charges of suspended solids adhering to small oil droplets may disrupt the stability of some emulsions. Increased contact angle of water against oil allows small oil droplets to coalesce into larger droplets, float out of the water and be removed by separation apparatus.

Directing an aqueous-based fluid mixture to pass through the presently claimed and/or disclosed inventive concepts may cause at least one dissimilar material in the fluid mixture to be repelled from the fluid containing at least one polar substance and facilitate its removal from the fluid, and thereby reduce the amount of flocculants and/or coagulants required for adequate dewatering processes so that drier solids and clearer filtrate may be discharged from dewatering equipment.

At least one chemical dispersing apparatus having a capacity to distribute a supply of at least one processing chemical into an aqueous-based fluid mixture directed to pass through magnetic energy may be utilized to disperse a supply of at least one chemical into a fluid upstream of the magnetically conductive conduit, downstream of the magnetically conductive conduit, upstream of the ceramic membrane filtration apparatus, and/or downstream of the ceramic membrane filtration apparatus. Processing chemicals may be selected from a group consisting of, but not limited to, algaecides, biocides, scale retardants, coagulants and flocculants and hydrogen peroxide.

In some instances, chemical pretreatment may hamper the efficiency of separation apparatus that tend to blind off with chemically treated fluids. Improved removal of at least one dissimilar material from a fluid containing the at least one polar substance may be achieved by directing an aqueous-based fluid mixture free of coagulants or flocculants to pass through the magnetically conductive conduit upstream of such separation apparatus to enhance the separation of at least one dissimilar material from the fluid containing the at least one polar substance.

Reducing the contact angle and/or lowering the viscosity of a fluid improves mechanical blending and allows at least one processing chemical to be more readily dispersed and evenly distributed within a conditioned fluid medium (such as magnetically conditioned water). The presently claimed and/or disclosed inventive concepts include a method of fluid conditioning, including the steps of establishing a flow of a fluid containing at least one polar substance and/or an aqueous-based fluid mixture through a magnetically conductive conduit having magnetic energy directed along the longitudinal axis of the magnetically energized conduit and extending through at least a portion of the fluid thereby altering the cohesion energy, viscosity, and/or contact angle against a dissimilar material of the fluid and thereby producing a conditioned fluid medium; and dispersing an amount of at least one processing chemical into the conditioned fluid medium to form a continuous mixture. At least one processing chemical may also be dispersed into the fluid containing at least one polar substance and/or the aqueous-based fluid mixture prior to magnetically conditioning of the fluid.

A processing chemical may be selected from a group consisting of, but not limited to, algaecides, biocides, scale retardants, coagulants and flocculants, surfactants, ambient air, oxygen, ozone and hydrogen peroxide. For example, reducing the contact angle against a dissimilar material and/or lowering the viscosity of water allows coagulants and flocculants more readily disperse and be evenly distributed within a conditioned fluid medium, improving the clarification of raw water.

In another aspect of the presently disclosed and/or claimed inventive concept, the above described methods may further include a step of recovering the fluid containing at least one polar substance from the conditioned fluid medium, wherein the removed fluid containing at least one polar substance has a reduced volume of the at least one dissimilar material therewith, and a step of recovering the at least one dissimilar material from the conditioned fluid medium.

An aqueous-based fluid mixture may be directed to a collection vessel and/or pretreatment apparatus to facilitate the separation of contaminants from the fluid. The aqueous-based fluid mixture may then be directed to pass through at least one magnetically conductive conduit having magnetic energy directed along the longitudinal axis of the magnetically energized conduit and extending through at least a portion of the aqueous-based fluid mixture thereby providing a conditioned fluid medium, then directed to pass through a first separation apparatus having a capacity to extract contaminants from the conditioned fluid medium and discharged as a conditioned fluid medium having a reduced volume of contaminants within the conditioned fluid medium. The conditioned fluid medium may further be directed to pass through a second separation apparatus having a capacity to extract contaminants from the conditioned fluid medium; then discharged as a conditioned fluid medium having a reduced volume of contaminants within the conditioned fluid medium. In some instances, it may be desirable to disperse at least one processing chemical into the aqueous-based fluid mixture and/or the conditioned fluid medium prior to directing the conditioned fluid medium to pass through a separation apparatus. The conditioned fluid medium may be directed to subsequent processing apparatus to extract any remaining dissimilar materials and/or contaminants from the fluid. At least one magnetically conductive conduit may be deployed upstream of a collection vessel, pretreatment apparatus and/or separation apparatus.

The presently claimed and/or disclosed inventive concepts include a method of separating at least one dissimilar material from an aqueous-based fluid mixture, including the steps of establishing a flow of the aqueous-based fluid mixture through the magnetically conductive conduit having magnetic energy directed along the longitudinal axis of the magnetically energized conduit and extending through at least a portion of the aqueous-based fluid mixture thereby providing a conditioned fluid medium; and directing a flow of at least a portion of the conditioned fluid medium through a ceramic membrane filtration apparatus, wherein the at least one dissimilar material separates from the conditioned fluid medium at an increased rate as compared to a rate of separation of the at least one dissimilar material from a substantially identical volume of the aqueous-based fluid mixture that has not been subjected to a magnetic field. At least one processing chemical may be dispersed in the aqueous-based fluid mixture. At least one processing chemical may be dispersed in the conditioned fluid medium.

As such, the presently disclosed and/or claimed inventive concept(s) are directed to a system and method whereby an aqueous-based fluid mixture may have one or more of its physical properties altered by subjecting the fluid to a sufficient amount of magnetic force prior to flowing through a ceramic membrane. Without intending to be bound to a particular theory, magnetically conditioning an aqueous-based fluid mixture prior to flowing through a ceramic membrane, as described herein, has been found to decrease the viscosity of the aqueous-based fluid to improve the flow characteristics of the aqueous-based fluid mixture through a ceramic membrane.

In one aspect of the presently disclosed and/or claimed inventive concept(s), the method as described any one of the methods described above regarding subjecting an aqueous-based fluid mixture to a magnetic field prior to flowing through a ceramic membrane, wherein at least one of a positive polarity, a negative polarity or switching between a positive polarity and a negative polarity of the magnetic field results in a decrease in the viscosity of the aqueous-based fluid mixture that has been subjected to the magnetic field as compared to the viscosity of an aqueous-based fluid mixture that has not been subjected to the magnetic field.

Depending on the polarity induced by the magnetic conditioning and the surface energy properties of a dissimilar material in a fluid mixture, the contact angle of a dissimilar material against water and/or an aqueous-based fluid that has been subjected to the magnetic field may be increased as compared to the contact angle of a dissimilar material against water and/or an aqueous-based fluid that has not been subjected to the magnetic field. Increasing the contact angle of water and/or an aqueous-based fluid a dissimilar material against and/or lowering the viscosity of water and/or an aqueous-based fluid typically improves mechanical separation.

The transmembrane pressure required to pass a volume of a conditioned fluid medium at a constant flux rate through a ceramic membrane may be reduced as compared to the pressure required to pass a substantially identical volume of an aqueous-based fluid mixture that has not been subjected to a magnetic field at a substantially identical constant flux rate through the same ceramic membrane. The flux rate of a volume of a conditioned fluid medium propelled at a constant pressure through a ceramic membrane may be increased as compared to the flux rate of a substantially identical volume of an aqueous-based fluid mixture that has not been subjected to a magnetic field propelled at a substantially identical constant pressure through the same ceramic membrane. A volume of a conditioned fluid medium may pass through a ceramic membrane at a reduced pressure and increased flux rate compared to the pressure and flux rate for a substantially identical volume of an aqueous-based fluid mixture that has not been subjected to a magnetic field to pass through the same ceramic membrane.

By way of example, a first aqueous-based fluid mixture that has not been subjected to the magnetic field may pass through a ceramic membrane at a constant flux rate of 130 gfd with a transmembrane pressure ranging from 5 psi to 10 psi, and a first conditioned fluid medium may pass through the same ceramic membrane at the same constant flux rate with a transmembrane pressure ranging from 5 psi to 7.5 psi. In a second example, a second aqueous-based fluid mixture that has not been subjected to the magnetic field may pass through a ceramic membrane at a constant flux rate of 70 gfd with a transmembrane pressure ranging from 5 psi to 10-12 psi, and a second conditioned fluid medium may pass through the same ceramic membrane at the same constant flux rate with a transmembrane pressure ranging from 4.5 psi to 5.5 psi.

Depending on the composition of one or more fluids containing at least one polar substance and, optionally, one or more dissimilar materials in the one or more fluids, at least one of the embodiments described above can be used to, for example but without limitation, (i) increase the rate by which a dissimilar material separates from an aqueous-based fluid, (ii) encourage phase separation of at least two separate phases (e.g., one or more fluid containing at least one polar substance and a solid material phase and/or a hydrocarbon phase), (iii) reduce the pressure to pass an aqueous-based fluid through a ceramic membrane at a constant temperature (iv) increase the flux rate of an aqueous-based fluid through a ceramic membrane under constant temperature and at a constant temperature and/or (v) separate at least one biological contaminant from one or more fluid containing at least one polar substance.

The following examples illustrate via experimental analysis the extent that certain physical properties like the cohesion energy, contact angle and viscosity, can be altered for a fluid containing at least one polar substance (as defined herein) when subjected to, for example, a magnetic field of approximately 150 to 7500 gauss.

### First Experimental Field Test at about 130 Gallon Per Square Feet Per Day (130 GFD)

The presently claimed and/or disclosed inventive concepts of increasing the efficiency of phase separation of a dissimilar material from an aqueous-based fluid mixture (e.g., lake water flowing through a ceramic membrane filtration apparatus) were quantified in a first field test example at a flux rate equivalent of about 130 gallon per square feet per day (130 GFD), as follows: An operator was processing water drawn from an adjacent lake. The lake water typically contained trace amounts of solids, organic and biological contaminants. Ceramic membrane filters rated at 0.03μ were utilized to remove contaminants from the lake water to reduce fouling of heating, cooling and processing equipment.

The filtration system operated at a flux rate equivalent of 130 GFD. 1 part per million (ppm) of aluminum chlorohydrate (ACH) coagulant was injected into the aqueous-based fluid mixture (lake water) upstream of the filtration system. During the continuous operation of the system, backwash cycles were programmed to occur at 15-minute intervals.

The clean filtration system operated with a transmembrane pressure of 5 psi. During filtration of the lake water and ACH mixture, the TMP of the system gradually climbed to 10 psi until the beginning of a regularly scheduled backwashing cycle. After backwashing, the system returned to the 5 psi TMP of a clean system. The ultrafiltration system ran continuously and consistently provided filtered water in the 1-5 NTU range over a two day period.

The conditioned fluid medium samples analyzed in this “first experimental field test at about 130 GFD” were generated with the identical field trial apparatus utilized to generate the magnetically conditioned samples of the “first field test example at gauss levels of about 7500” disclosed in the U.S. patent application Ser. No. 15/797,829 comprising a serial connection of an embodiment of the presently claimed and/or disclosed magnetically conductive conduit having inside diameters of approximately 2″.

As disclosed herein in a first example, a length of new ½″ plastic tubing was deployed through the serial coupling of the first and second 2″ fluid flow conduits with the tubing extending through each end of the conduit to establish a fluid flow path; with the tubing being made of a material that, in and of itself, would not affect any physical properties of an aqueous-based fluid mixture sample. A closed loop system having a five gallon collection vessel, a 12 VDC diaphragm pump energized with a variable power supply and a length of ½″ plastic tubing sleeved within the serial coupling of the first and second 2″ fluid flow conduits was utilized to generate water samples, with the variable power supply providing an adjustable amount of electrical energy to energize the DC pump and control the fluid flow rate of approximately 4 gallons per minute (gpm). The aqueous-based fluid mixture (lake water) was drawn from collection vessel by the pump and propelled through the magnetically conductive conduit before being returned to the collection vessel.

Untreated Lake Water samples were generated by propelling lake water through the magnetically conductive conduit with the electrical power supply connected to the at least one coiled electrical conductor switched “OFF” and Magnetically Conditioned Lake Water samples were generated by propelling lake water through the magnetically energized conduit with the electrical power supply switched “ON”.

No aluminum chlorohydrate (ACH) coagulant was injected into the conditioned fluid medium upstream of the filtration system. The conditioned fluid medium was directed to pass through the ultrafiltration system at an identical flux rate equivalent of 130 GFD, and identical backwash cycles were programmed to occur at 15-minute intervals.

During filtration of the conditioned fluid medium, the system operated with a transmembrane pressure of 5 psi immediately after a backwash cycle and gradually climbed to 5.5-7.5 psi until the beginning of a regularly scheduled backwashing cycle. After backwashing, the system returned to the 5 psi TMP of a clean system. Ultrafiltration of the conditioned fluid medium ran continuously for one day and consistently generated filtered water in the 1-5 NTU range.

Ultrafiltration of the conditioned fluid medium resulted in an average reduction in TMP of approximately 34.5% and a 100% savings on ACH when compared to a rate of separation of the at least one dissimilar material from the non-magnetically conditioned aqueous-based fluid mixture. Such results are shown in Table 1.

TABLE 1
Untreated Lake Water vs. Conditioned Lake Water at 130 GFD
Lake Water Filtered through Ceramic Membrane at a Constant Flux Rate of 130 GFD
Untreated and Magnetic Conditioning (Flowing through Magnet)

| | Pressure of | | | | |
|---|---|---|---|---|---|
| Pressure of | Magnetically | | | | |
| Untreated | Conditioned | | ACH | ACH Dosage | |
| Lake Water | Lake Water | Average % | Dosage | of | Reduction |
| at Beginning | at Beginning | Change | of | Magnetically | of ACH Dosage |
| of a | of a | of | Untreated | Conditioned | with |
| Backwash | Backwash | Pressure @ | Lake | Lake | Magnetic |
| Cycle | Cycle | 130 GFD | Water | Water | Conditioning |
| 10.0 psi | 5.5-7.5 psi | 34.5% | 1.0 ppm | 0.0 ppm | 100.0% |

The presently claimed and/or disclosed inventive concepts also include a method of reducing the pressure to propel an aqueous-based fluid mixture through a ceramic membrane filtration apparatus at a constant flux rate at ambient temperature, including the steps of establishing a flow of the aqueous-based fluid mixture through a magnetically conductive conduit having magnetic energy directed along the longitudinal axis of the magnetically energized conduit and extending through at least a portion of the aqueous-based fluid mixture, thereby providing a conditioned fluid medium; and propelling the conditioned fluid medium at a constant flux rate through a ceramic membrane filtration apparatus downstream of the magnetically conductive conduit, wherein the pressure to propel a volume of the conditioned fluid medium at a constant flux rate through the ceramic membrane filtration apparatus at ambient temperature is reduced as compared to the pressure to propel a substantially identical volume of the fluid containing at least one polar substance and at least one dissimilar material prior to magnetic conditioning at a substantially identical constant flux rate through the ceramic membrane filtration apparatus at ambient temperature.

### Second Experimental Field Test at about 70 GFD

In addition to the first experimental field trial identified above at about 130 GFD, a second field trial was conducted to quantify the increased efficiency at which contaminants separate from lake water (i.e., aqueous-based fluid mixture) using the general methods and apparatus disclosed above at a flux rate of about 70 GFD. The results as well as the specifics of the method and apparatus are as follows: An operator was processing water drawn from an adjacent lake from use in industrial operations. The lake water typically contained high levels of solids, organic and biological contaminants. An ultrafiltration system having ceramic membrane filters rated at 0.03μ was utilized to remove contaminants from the lake water to reduce fouling of heating, cooling and processing equipment.

The ultrafiltration system operated at a flux rate equivalent of 70 GFD. Due to the high level of contaminants in the lake water, 20 ppm of aluminum chlorohydrate (ACH) coagulant was injected into the aqueous-based fluid mixture (lake water) upstream of the filtration system. During the continuous operation of the system, backwash cycles were programmed to occur at 15-minute intervals. A regularly scheduled Clean In Place (CIP) of the system was conducted every seven (7) days.

The clean ultrafiltration system operated with a transmembrane pressure of 5 psi. During filtration of the lake water and ACH mixture, the TMP of the system gradually climbed to 10-12 psi until the beginning of a regularly scheduled backwashing cycle. After backwashing, the system returned to a TMP of 5 psi.

The clean ultrafiltration system operated with a membrane permeability of 14 gallons per square feet per day (surface area expressed as gfd) per pounds per square inch of pressure expresses as psi, or 14 gfd/psi. During filtration of the lake water and ACH mixture, the gfd/psi of the system was gradually reduced to 5-7 gfd/psi until the beginning of a regularly scheduled backwashing cycle. After backwashing, the system returned to the 14 gfd/psi of a clean system.

The ultrafiltration system ran continuously and consistently generated filtered water in the 5-10 NTU range over a four week period.

The conditioned fluid medium samples analyzed in this “second experimental field test at about 70 GFD” were generated with an equivalent field trial apparatus utilized to generate the magnetically conditioned samples of the “first field test example at gauss levels of about 7500” disclosed in the U.S. patent application Ser. No. 15/797,829 comprising a serial connection of an embodiment of the presently claimed and/or disclosed magnetically conductive conduit having inside diameters of approximately 2″.

As disclosed herein in a second example, the field trial apparatus utilized to generate the magnetically conditioned samples of the “second experimental field test at about 70 GFD” comprised a serial connection of an embodiment of the presently claimed and/or disclosed magnetically conductive conduit having inside diameters of approximately 2″ installed immediately upstream of the ceramic membrane filtration apparatus. The aqueous-based fluid mixture (lake water) was drawn from lake by a pump and propelled through the magnetically energized conduit at a flow rate of 50 gpm before being directed to a collection vessel to generate a conditioned fluid medium. The conditioned fluid medium was then drawn from the collection vessel and pumped through the ceramic membrane filtration system at a flux rate of approximately 70 GFD. Automated controls were utilized to maintain a level of the conditioned fluid medium in the collection vessel to allow for the continuous, uninterrupted flow of the conditioned lake water through the ceramic membrane filtration system.

Untreated Lake Water samples were generated by propelling lake water through the magnetically conductive conduit with the electrical power supply connected to the at least one coiled electrical conductor switched “OFF” and Magnetically Conditioned Lake Water samples were generated by propelling lake water through the magnetically energized conduit with the electrical power supply switched “ON”.

20 ppm of aluminum chlorohydrate (ACH) coagulant was injected into the conditioned fluid medium upstream of the filtration system. The conditioned fluid medium was directed to pass through the filtration system at an identical flux rate of 70 GFD, and identical backwash cycles were programmed to occur at 15-minute intervals.

During filtration of the conditioned fluid medium and ACH, the system operated with a transmembrane pressure of 4.5-5.4 psi immediately after a backwash cycle and gradually climbed to 4.6-5.5 psi until the beginning of a regularly scheduled backwashing cycle. After backwashing, the system returned to the 4.5 psi TMP of a clean system.

During filtration of the conditioned lake water and ACH, the gfd/psi of the system operated at 12-16 gfd/psi until the beginning of a regularly scheduled backwashing cycle. After backwashing, the permeability of the system remained in the 12-16 gfd/psi range.

During filtration of the conditioned fluid medium and ACH, the system ran continuously and consistently generated filtered water in the 1-4 NTU range over a two week period. Ultrafiltration of the conditioned fluid medium ran continuously for one day and consistently generated filtered water in the 1-5 NTU range.

Ultrafiltration of the conditioned fluid medium resulted in an average reduction in TMP of approximately 54.09%, an average increase in the permeability of the ceramic membrane of approximately 57.14% and an average reduction in the turbidity of the filtered water of approximately 50% when compared to a rate of separation of the at least one dissimilar material from the non-magnetically conditioned aqueous-based fluid mixture, providing substantial cost savings and water processing benefits for the end user. Such results are shown in Table 2.

TABLE 2
Untreated Lake Water vs. Conditioned Lake Water at 70 GFD
Lake Water Filtered through a Ceramic Membrane at a Constant Flux Rate of 70 GFD
Untreated and Magnetic Conditioning (Flowing through Magnet)

| | | | Permeability | Permeability | Average |
|---|---|---|---|---|---|
| | | | of | of | Increase |
| Pressure of | Pressure of | | Membrane | Membrane | In |
| Untreated | Magnetically | | with | with | Permeability |
| Lake Water | Conditioned | | Untreated | Conditioned | of |
| at | Lake Water | Average % | Lake Water | Lake Water | Ceramic |
| Beginning | at Beginning | Change | at Beginning | at Beginning | Membrane |
| of a | of a | of | of a | of a | with |
| Backwash | Backwash | Pressure @ | Backwash | Backwash | Magnetic |
| Cycle | Cycle | 70 GFD | Cycle | Cycle | Conditioning |
| 10-12 psi | 4.6-5.5 psi | 54.09% | 5-7 gfd/psi | 12-16 gfd/psi | 57.14% |

### Third Experimental Field Test of the Flow Rates of Tap Water at Various Pressures

In another example, a closed loop system having a five gallon collection vessel, a 12 VDC diaphragm pump energized with a variable power supply, a flow meter, and a magnetically conductive conduit comprising a serial coupling of conduit segments having a 1.050″ outside diameter boundary wall and a length of approximately 22″ and connected with ½″ plastic tubing (with the tubing being made of a material that, in and of itself, would not affect any physical properties of a fluid mixture sample) were utilized to generate untreated and magnetically conditioned fluid samples, with the variable power supply providing an adjustable amount of electrical energy to energize the DC pump and control the fluid flow rate. The closed loop system allowed fluid to be pulled from collection vessel by the pump and propelled through the flow meter and magnetically conductive conduit before being returned to the collection vessel.

The serial coupling of conduit segments comprised a non-magnetically conductive threaded coupling axially aligned between two magnetically conductive threaded conduit segments, each conduit segment having a wall thickness of approximately 0.113″. Female NPT pipe threads on each end of the non-magnetically conductive coupling matched the male NPT pipe threads on the ends of the magnetically conductive segments that were threaded into the coupling so that distance from the distal end of the first threaded magnetically conductive conduit to the proximal end of the second threaded magnetically conductive conduit was approximately ¾″.

A coil encircling at least a section of the outer surface of the magnetically conductive threaded conduits and the non-magnetically conductive threaded coupling was formed by winding 242 turns of a length of 14 AWG copper wire to form a 16″ layer, and then adding seven more layers to form a continuous coil having a total of 1936 turns encircling the serial coupling of conduit segments, wherein the length to diameter ratio of the coil was approximately 8:1. Untreated Tap Water samples were generated by propelling tap water through the magnetically conductive conduit with the electrical power supply energizing the copper wire coiled around the outer surface of the serial coupling of conduit segments switched “OFF”.

Four gallons of tap water were decanted into the collection vessel, the pump was energized and power supply adjusted to circulate the water through the system at a rate of 4.0 gpm. After circulating the water for 5 minutes to achieve a steady-state flow, a first sample of untreated tap water was collected in a collapsible plastic bladder. The water sample was then placed in a pneumatically driven flow evaluation system, wherein air pressure compressed the collapsible plastic bladder to propel the water sample through an adjustable solenoid valve and a 30″ length of 3/16″ stainless steel tubing before being decanted into a sample collection flask.

The solenoid valve, having a capacity to regulate fluid flow through an adjustable orifice at a predetermined pressure, was connected to an electric timer utilized to regulate the length of time the valve was open to allow for pneumatically driven fluid flow. Flow rates through the system were then determined by dividing the volume of water collected in the sample flask by the amount of time the solenoid valve was open to allow fluid to flow through the valve. The average flow rate of untreated water propelled at 20 psi through the system was determined to be 17.2 milliliters per second, or 0.0273 gpm and the average flow rate of untreated water propelled at 40 psi was determined to be 21.6 milliliters per second, or 0.0342 gpm.

A coiled electrical conductor encircling the magnetically conductive conduit was then energized with 12 VDC and approximately 5 amps of electrical energy to generate a magnetic field strength of approximately 1000 gauss near the center of the magnetically energized conduit, as well as a magnetic field strength of approximately 150 gauss concentrated at each end of the magnetically energized conduit. A second 4 gallon volume of tap water was circulated through the system at an identical rate of 4.0 gpm for approximately 10 minutes before a collecting samples of conditioned tap water making approximately 10 passes through the magnetically energized conduit.

The magnetically conditioned water samples were then placed in the pneumatically driven flow evaluation system and propelled through the solenoid valve at 20 psi and 40 psi. The average flow rate of magnetic conditioned water propelled at 20 psi through the flow evaluation system was determined to be 18.4 milliliters per second, or 0.0292 gpm; a 7.0% increase in flow rate as a result of magnetic conditioning and the average flow rate of magnetic conditioned water propelled at 40 psi through the flow evaluation system was determined to be 26.2 milliliters per second, or 0.0415 gpm, an increased flow rate of 21.3% as a result of magnetic conditioning. These results are shown in Table 3.

TABLE 3
Untreated Tap Water vs. Magnetically Conditioned Tap Water
Tap Water Propelled Through a Conduit at Pressure Untreated
and Magnetic Conditioning (Flowing through Energized Magnet)

| | Average | | | | |
|---|---|---|---|---|---|
| | Flow | | | | |
| Average | Rate of | Change in | Average | Average | Change in |
| Flow Rate | Magneti- | Flow Rate | Flow Rate | Flow Rate of | Flow Rate |
| of | cally | of | of | Magnetically | of |
| Untreated | Treated | Treated | Untreated | Treated | Treated |
| Tap Water | Tap Water | Tap Water | Tap Water | Tap Water | Tap Water |
| @ 20 psi | @ 20 psi | @ 20 psi | @ 40 psi | @ 40 psi | @ 40 psi |
| .0273 gpm | .0292 gpm | 7.0% | .0342 gpm | .0415 gpm | 21.3% |

The presently claimed and/or disclosed inventive concepts also include a method of increasing the flux rate of an aqueous-based fluid mixture propelled through a ceramic membrane filtration apparatus at a constant pressure at ambient temperature, including the steps of establishing a flow of the aqueous-based fluid mixture through a magnetically conductive conduit having magnetic energy directed along the longitudinal axis of the magnetically energized conduit and extending through at least a portion of the aqueous-based fluid mixture, thereby providing a conditioned fluid medium; and propelling the conditioned fluid medium at a constant pressure through a ceramic membrane filtration apparatus downstream of the magnetically conductive conduit, wherein the flux rate a volume of the conditioned fluid medium at a constant pressure through the ceramic membrane filtration apparatus at ambient temperature is increased as compared to the flux rate of a substantially identical volume of the fluid containing at least one polar substance and at least one dissimilar material prior to magnetic conditioning at a substantially identical constant pressure through the ceramic membrane filtration apparatus at ambient temperature.

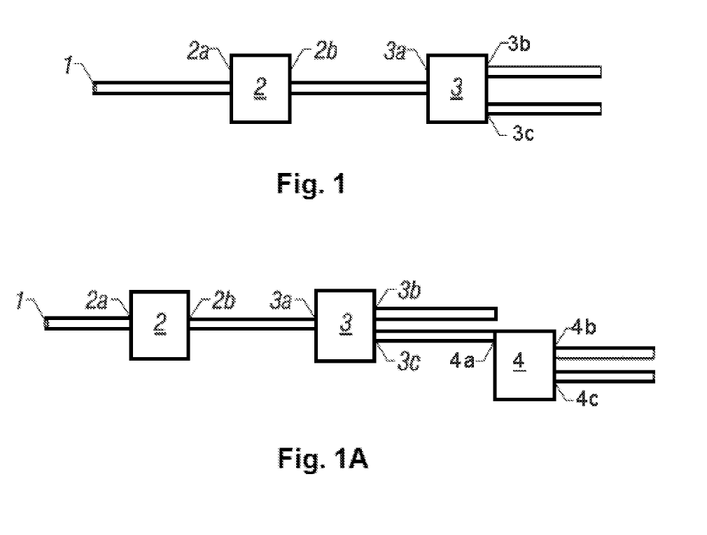

FIG. 1 is a schematic diagram of an embodiment of the presently claimed and/or disclosed inventive concepts for phase separation wherein a magnetically conductive conduit 2 is shown coupled to a ceramic membrane filtration apparatus 3 for fluid flow there between. An aqueous-based fluid mixture introduced to port 1 may be directed to pass through fluid entry port 2a at the proximal end of the magnetically conductive conduit before passing through magnetically conductive conduit 2 having magnetic energy directed along the longitudinal axis of the magnetically energized conduit. The aqueous-based fluid mixture may then be discharged from fluid discharge port 2b at the distal end of the magnetically conductive conduit as a conditioned fluid medium. The conditioned fluid medium may then be directed through inlet port 3a of ceramic filtration apparatus 3 having a capacity to separate the at least one dissimilar material from the conditioned fluid medium. A first amount of the conditioned fluid medium having a reduced volume of the at least one dissimilar material may be discharged through outlet port 3b and the separated at least one dissimilar material having a reduced volume of water may be discharged through outlet port 3c.

Multiple stage separation systems in series can be applied to achieve higher system recovery. Due to the modular nature of membrane processes, multiple modules can be arranged in parallel to treat greater volumes. A second stage membrane system can be utilized to treat the backwash waste water from a primary membrane system. This second stage system is typically operated at a lower flux rate than the primary system due to the concentrated suspended solids in the waste water.

FIG. 1A is a schematic diagram of an embodiment of the presently claimed and/or disclosed inventive concepts for separation of a first dissimilar material and a second dissimilar material from an aqueous-based fluid mixture wherein magnetically conductive conduit 2 is shown coupled to first separation apparatus 3 for fluid flow there between. The aqueous-based fluid mixture containing the first and the second dissimilar material introduced to port 1 may be directed to pass through fluid entry port 2a at the proximal end of the magnetically conductive conduit before passing through magnetic energy directed along the longitudinal axis of magnetically energized conduit 2. The aqueous-based fluid mixture may then be discharged from fluid discharge port 2b at the distal end of the magnetically conductive conduit as a conditioned fluid medium. The conditioned fluid medium may then be directed through inlet port 3a of first separation apparatus 3 having a capacity to separate a first dissimilar material from the conditioned fluid medium. An amount of the first dissimilar material may flow through outlet port 3b and be discharged as a first dissimilar material containing a reduced volume of the conditioned fluid medium. The conditioned fluid medium having a reduced volume of the first dissimilar material may then be discharged through outlet port 3c of first separation apparatus 3 before being directed through inlet port 4a of second separation apparatus 4 having a capacity to separate a second dissimilar material from the conditioned fluid medium. An amount of the second dissimilar material may flow through outlet port 4b and be discharged as a second dissimilar material containing a reduced volume of the conditioned fluid medium; and the conditioned fluid medium may flow through outlet port 4c and be discharged as a fluid containing at least one polar substance having a reduced volume of the first dissimilar material and the second dissimilar material.

In each embodiment of the presently claimed and/or disclosed inventive concepts for separating at least one dissimilar material from an aqueous-based fluid mixture and performing phase separation, it can be appreciated that magnetic energy may be concentrated in a plurality of distinct areas along the longitudinal axis of the magnetically energized conduit.

While the embodiments of the inventive concepts disclosed herein have been described for purposes of this disclosure, it will be understood that numerous changes may be made and readily suggested to those skilled in the art which are accomplished within the scope and spirit of the inventive concepts disclosed herein.

1. A method of reducing the pressure required to pass an aqueous-based fluid mixture propelled at a constant flux rate through a ceramic membrane at ambient temperature, comprising:
subjecting at least a portion of an aqueous-based fluid mixture to a magnetic field to provide a conditioned fluid medium, wherein the pressure required to pass a volume of the conditioned fluid medium at a constant flux rate through a ceramic membrane at ambient temperature is reduced as compared to the pressure required to pass a substantially identical volume of the aqueous-based fluid mixture that has not been subjected to a magnetic field at a substantially identical constant flux rate through the ceramic membrane at ambient temperature.

2. The method of claim 1, further having the step of recovering at least one dissimilar material from the conditioned fluid medium.

3. The method of claim 2, wherein the at least one dissimilar material is selected from the group consisting of hydrocarbon compounds, autotrophic organisms, chemical compounds, solid materials, fats, biological contaminants and combinations thereof.

4. The method of claim 1, wherein (i) the cohesion energy of the conditioned fluid medium is less than the cohesion energy of the aqueous-based fluid mixture prior to being subjected to the magnetic field, (ii) the viscosity of the conditioned fluid medium is less than the viscosity of the aqueous-based fluid mixture prior to being subjected to the magnetic field, and/or (iii) the contact angle of the conditioned fluid medium against a dissimilar material is greater than the contact angle of the aqueous-based fluid mixture against a dissimilar material prior to being subjected to the magnetic field.

5. The method of claim 1, wherein at least one processing chemical is dispersed in the aqueous-based fluid mixture.

6. The method of claim 1, wherein at least one processing chemical is dispersed in the conditioned fluid medium.

7. An apparatus for reducing the pressure required to pass an aqueous-based fluid mixture propelled at a constant flux rate through a ceramic membrane at ambient temperature, including:
a magnetically conductive conduit having magnetic energy directed along the longitudinal axis of the magnetically conductive conduit and extending through at least a portion of the magnetically conductive conduit; and
a ceramic membrane filtration apparatus downstream of the magnetically conductive conduit, wherein the aqueous-based fluid mixture is capable of flowing through the magnetically conductive conduit and into the ceramic membrane filtration apparatus.

8. The apparatus of claim 7, wherein the magnetically conductive conduit further has a fluid entry port at the proximal end of the magnetically conductive conduit, a fluid discharge port at the distal end of the magnetically conductive conduit and a fluid impervious boundary wall extending between the fluid entry port and the fluid discharge port, an inner surface of the boundary wall establishing a fluid flow path extending along the longitudinal axis of the conduit.

9. The apparatus of claim 8, wherein the magnetically conductive conduit further has at least one electrical conductor having a first conductor lead and a second conductor lead, the electrical conductor coiled with at least one turn to form at least one uninterrupted coil of electrical conductor, each coil forming at least one layer of coiled electrical conductor.

10. The apparatus of claim 9, wherein the magnetically conductive conduit further has at least one coiled electrical conductor encircling the magnetically conductive conduit, wherein the at least one coiled electrical conductor sleeves at least a section of an outer surface of the magnetically conductive conduit with at least one turn of the electrical conductor oriented substantially orthogonal to the fluid flow path extending through the conduit.

11. The apparatus of claim 10, wherein the magnetically conductive conduit further has at least one electrical power supply operably connected to at least one of the first and second conductor leads, wherein the at least one coiled electrical conductor is thereby energized to provide a magnetic field having lines of flux directed along the longitudinal axis of the magnetically energized conduit.

12. The apparatus of claim 11, wherein the magnetic field is concentrated in a plurality of distinct areas along the longitudinal axis of the magnetically conductive conduit.

13. The apparatus of claim 8, wherein the ceramic membrane filtration apparatus has a fluid impervious boundary wall having an inner surface, an inlet port for receiving a magnetically conditioned fluid medium, a first outlet port for discharging a first amount of the conditioned fluid medium having a reduced volume of at least one dissimilar material and a second outlet port for discharging at least one dissimilar material containing a reduced volume of the conditioned fluid medium.

14. A method of increasing the flux rate of an aqueous-based fluid mixture propelled at a constant pressure through a ceramic membrane at ambient temperature, comprising:
subjecting at least a portion of an aqueous-based fluid mixture to a magnetic field to provide a conditioned fluid medium, wherein the flux rate of a volume of the conditioned fluid medium propelled at a constant pressure through a ceramic membrane at ambient temperature is increased as compared to the flux rate of a substantially identical volume of the aqueous-based fluid mixture that has not been subjected to a magnetic field propelled at a substantially identical constant pressure through the ceramic membrane at ambient temperature.

15. The method of claim 14, further having the step of recovering at least one dissimilar material from the conditioned fluid medium.

16. The method of claim 15, wherein the at least one dissimilar material is selected from the group consisting of hydrocarbon compounds, autotrophic organisms, chemical compounds, solid materials, fats, biological contaminants and combinations thereof.

17. The method of claim 14, wherein (i) the cohesion energy of the conditioned fluid medium is less than the cohesion energy of the aqueous-based fluid mixture prior to being subjected to the magnetic field, (ii) the viscosity of the conditioned fluid medium is less than the viscosity of the aqueous-based fluid mixture prior to being subjected to the magnetic field, and/or (iii) the contact angle of the conditioned fluid medium against a dissimilar material is greater than the contact angle of the aqueous-based fluid mixture against a dissimilar material prior to being subjected to the magnetic field.

18. The method of claim 14, wherein at least one processing chemical is dispersed in the aqueous-based fluid mixture.

19. The method of claim 14, wherein at least one processing chemical is dispersed in the conditioned fluid medium.

20-26. (canceled)
